(19) United States
(12) Patent Application Publication
(10) Pub. No.: US 2006/0011041 A1
(43) Pub. Date: Jan. 19, 2006

(54) Banjo wood ring alteration

(76) Inventors: James Sidney Barrett, Merrimack, NH (US); Philip A. Fontaine, Lula, GA (US)

Correspondence Address: James S. Barrett, P.O. Box 785, Merrimack, NH, 03054, US

(21) Appl. No.: 11/105,303

(22) Filed: Apr. 12, 2005

Related U.S. Application Data
(60) Provisional application No. 60/561,569, filed on Apr. 13, 2004.

(51) Int. Cl. G10D 1/10

(52) U.S. Cl. 84/269

(57) ABSTRACT

This invention, the Banjo Wood Ring Alteration, alters the five string banjo's wooden ring (rim) by drilling a series of 64 holes in the ring structure at various diameters, depths and locations. This is performed, on standard size wooden banjo rings, with common drill presses, portable drills, and drill bits.

### INVENTION DESCRIPTION

Banjos are typically made with wooded rings (also called rims, hoops, or shells). These are primarily constructed with a stack (block) lamination or bent lamination method. The inventors utilize a stack lamination system with a series of 64 holes drilled into the ring. The invention is used on five-string, bluegrass banjos with resonators (not open-back banjos). The ring size is 0.906″ thick, 2.750″ high, and 11.000″ in outside diameter. This outside diameter is standard for bluegrass banjos; however, some manufacturers will vary the rim thickness and height. The ring of a standard banjo can be altered using this design invention without changing the size, construction techniques, or required strength of the ring structure. (See the attached scaled drawings of this alteration. Also isometric views are enclosed through three attached photos.)

This invention achieves its results by both attenuating unwanted acoustic resonance and supporting desirable harmonics. When the banjo's strings are “picked”, they transfer their vibrational energy through the bridge and set the tensioned drum head of the banjo into a corresponding oscillation. The sound generated by the head emanates from both its front and back surfaces. The sound from the rear surface of the head enters the banjo's ring/resonator chamber. The sound waves hitting the interior surface of the wooded ring are absorbed, transmitted, or reflected. The drum head is also in directed contact with a heavy metal tone ring which is fitted to the wooden ring. This highly elastic tone ring, efficiently transfer head vibrations into the wooden ring where they are then dissipated into the air.

This invention achieves its results as follows. The reduced mass of the ring, (8½% reduction), lowers the resonant frequency of the rim about two half steps of the, A=440 Hz. chromatic scale. This allows the banjo to produce a lower frequency tone response. Also, the 32 holes drilled into the inside of the ring, lower the amplitude and duration of the standing waves within the ring, essentially the inside of a 9¼″ diameter cylinder. These standing waves have a peak response at 1480 Hz., which is in the midrange of audible sound, the region where the human ear is most sensitive. The other 32 holes drilled into the back of the ring at various depths and diameters act to support desirable harmonics and correlate to an F# Major chord, the major seventh in the instrument's G tuning. This is accomplished by drilling three different depths of holes who's wavelengths correspond to the notes of the desired overtones. Varying the diameter of the holes from ½″ to ⅛″ in 1/16″ increments, helps prevent a peak at any one upper register harmonic frequency.

The overall effect of this specific drilling alteration to the wooden ring is a flatter, more uniform frequency response with enhanced low and high frequencies and an attenuation of peaks in the midrange. A professional banjo manufacturer has produced several five-string banjos using this alteration and the sound has been described as being “clear” when played by professional musicians. Many engineers still consider the human ear to be the best judge of tonal qualities, dynamics, timbre, and harmonic characteristics. A comparison of frequency response curves for banjo rims with and without this alteration, is being set up. The test results will be available upon request.

### ALTERNATIVE EMBODIMENTS

Other uses of this invention could include related acoustic instruments and drums where a drum head is tensioned against a wooded ring or cylinder.

### PATENT SEARCH INFORMATION

The term “banjo” can also mean a type of bolt used in brake systems. It is necessary to restrict a search to stringed musical instruments in the case of alterations to the five-string banjo. A USPTO search revealed no related inventions since 1975. (A partial list of search results is enclosed)

1) This invention, changes the banjo's frequency response, by attenuating certain upper midrange frequencies, and augmenting certain bass and treble frequencies. The resulting acoustical change effects the way a listener will perceive the tone and dynamics of the banjo. This reduction in sound levels in the upper midrange region allows the listener to hear more detail in other areas of the audio spectrum.

2) The inventors claim an improvement in the sound quality of the instrument because of a more even frequency response, louder and clearer sounding fundamental frequencies, and more prominent desired overtones.
